(19) United States
(12) Patent Application Publication
(10) Pub. No.: US 2005/0096931 A1
(43) Pub. Date: May 5, 2005

(54) System for managing data regarding derivatives trades

(75) Inventors: Richard A. Baker, Evanston, IL (US); Brian Laird, Carpentersville, IL (US); Lance Klein, Naperville, IL (US); Matt Sweetnam, Planfield, IL (US); Brent Billows, Chicago, IL (US); Steven Karlovitz, Glendale Heights, IL (US); John Compall, Des Plaines, IL (US); Diane Schuering, Chicago, IL (US); Marc MacQuarrie, Chicago, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: The Clearing Corporation, Chicago, IL (US)

(21) Appl. No.: 10/804,531

(22) Filed: Mar. 19, 2004

Related U.S. Application Data
(60) Provisional application No. 60/457,233, filed on Mar. 25, 2003.

(51) Int. Cl. G06F 17/60

(52) U.S. Cl. 705/1; 705/14

(57) ABSTRACT

A system for managing data regarding derivatives trades is configured to support the operations of a derivatives clearinghouse. The system may be implemented with a web server and a database server. The web server receives requests from client computers for information regarding trades that have been previously accepted by the clearinghouse and, in coordination with the database server, provides the information to the client computers.

### CROSS-REFERENCE TO RELATED APPLICATIONS

This Application claims the benefit of the filing date of U.S. Provisional Application Ser. No. 60/457,233, which is entitled METHOD AND SYSTEM FOR CLEARING TRADES and was filed on Mar. 25, 2003.

### FIELD OF THE INVENTION

This invention relates generally to the management of data for previously-executed derivatives trades. More particularly, the invention relates to managing such data in support of the operations of a derivatives clearinghouse.

### BACKGROUND OF THE INVENTION

A derivative is a financial contract written on an underlying asset whose value is derived from the value of this asset or whose value is derived from the value of another asset. Two major types of derivatives are futures (or forwards) and options.

A futures contract, or future, is a contract between a buyer and a seller to buy or sell a specified quantity of a commodity or a financial instrument at an agreed price on a designated future date. The delivery price is fixed at the time the contract is agreed upon. An option, in contrast, is a contract that gives the purchaser the right, but not the obligation, to buy or sell a futures contract, or a specified quantity of a commodity or a financial instrument, at an agreed-upon price.

The act of buying or selling a derivative is referred to as a “trade.” Thus, every derivative trade involves two parties: a seller, who is selling the derivative, and a buyer. The trading of derivatives frequently occurs on an “exchange,” but may also occur off an exchange in the over-the-counter (“OTC”) markets. A derivatives exchange is a regulated institution that provides a forum for buyers and sellers of derivatives to conduct their trades, while OTC derivatives markets may not be regulated. Examples of derivatives exchanges include Eurex, Eurex US, the Chicago Mercantile Exchange, and the Chicago Board of Trade. Examples of OTC markets include CDXchange and ChemConnect.

The execution of a trade occurs either through an electronic trading system, such as Eurex US's system, or in a trading pit, where the trade is conducted verbally (also referred to as “open outcry”). When a buyer and a seller commit to a price for which a future or option is to be bought or sold, the trade is said to have been “executed.” As used herein, the terms “trade” and “executed trade” shall be interchangeable and shall have the same meaning. When a trade is executed via open outcry, the buyer and the seller each create a record that contains the details of the executed trade. The buyer's record and the seller's record of the trade are sent to an institution known as a “clearinghouse.” The clearinghouse compares the seller's record with the buyer's record. If the two records are consistent with one another, then a “match” is said to have occurred. Alternatively, in a fully electronic system that does not rely on an open outcry process, the exchange or OTC marketplace itself automatically matches the buyer's and seller's records, so that by the time a record of the trade is sent to the clearinghouse, the trade is already designated as “matched.”

A clearinghouse typically has “participants,” each of whom is either a derivatives trading firm or an individual trader. Only participants of the clearinghouse are permitted to “clear” trades through the clearinghouse. If a derivative trading firm (or an individual trader) is not a participant of the clearinghouse, then it must submit its records of trades through a firm that is a participant in the clearinghouse in order to have the trades cleared. The clearinghouse performs a number of functions, among which may be the function of accepting a trade after it has been matched, succeeding to the rights of the original parties to the trade, and assuming the obligations of the original parties to the trade. A clearinghouse also performs such tasks as: settling the trade through its clearing participants; collecting and maintaining margin monies; handling the assignment of collateral; and reporting trade data. Examples of clearinghouses include The Clearing Corporation (formerly known as the Board of Trade Clearing Corporation), the New York Clearing Corporation (NYCC), London Clearing House (LCH), and the Options Clearing Corporation (OCC).

As derivatives markets have become increasingly computerized, the need for more sophisticated ways for clearinghouses to maintain and manage data regarding derivatives trades has grown accordingly.

### SUMMARY OF THE INVENTION

According to an embodiment of the invention, a computer system for supporting a derivatives clearinghouse is provided. The computer system includes a web server that receives a request for a web page from a remote computer, and provides a graphical user interface to the remote computer in response to the request. The web server also receives, through the graphical user interface, a request for a list of trades that were previously accepted by the clearinghouse, and to which a first participant of the plurality of participants was a party. The web server provides the list to the remote computer via the graphical user interface. The remote computer transmits an input indicating that a trade on the list was improperly accepted. In this embodiment, the computer system also has a database server communicatively linked with the web server. The database server maintains a database of derivatives trades that have been accepted by the clearinghouse, and retrieves data associated with accepted trades. The database server also provides the retrieved data to the web server for use in creating the list, and creates an entry in the database that represents another accepted trade.

According to another embodiment of the invention, the web server presents a second graphical user interface to a second remote computer, and queries the second participant, via the second graphical user interface, regarding whether the acceptance of the trade should be negated. In this embodiment, the database server performs the creating step only if the second participant indicates that the acceptance of the trade should be negated.

In yet another embodiment of the invention, the database server receives a structured query language search command, and searches the database in accordance with the structured query language search command. The database server then retrieves the data associated with the accepted trades based on the search.

In still another embodiment of the invention, a computer system for managing data regarding derivatives trades has a first server communicatively linked to a first remote computer and a second remote computer. The first server receives a first data record from the first remote computer, which reflects data recorded by the first party regarding a derivatives trade. The first server also receives a second data record from the second remote computer, which reflects data recorded by the second party regarding the derivatives trade. The computer system also has a second server that maintains a database. The second server stores the first and second data records in a database, and classifies the first and second data records as unmatched. The second server also retrieves, from the database, a plurality of unmatched data records in which the underlying trade involved the first party, including the first and second data records. The second server then provides the plurality of unmatched data records, including the first and second data records, to the first server. Upon receiving the records from the second server, the first server displays their contents on a user interface and displays the user interface to the first party on a display of a computer. The first server then receives an input from the first party indicating that the first data record and the second data record should match. In response, the second server edits the first data record so that it matches the second data record.

In still another embodiment of the invention, the second server periodically attempts to match the records that are categorized as unmatched into pairs, such that each pair includes a buyer's record of-a particular derivatives trade and a seller's record of the particular derivatives trade. After editing the first data record so that it matches the second data record, the second server matches the first data record and the second data record during one of the periodic attempts. After the second server matches the first and second data records, the clearinghouse accepts the trade represented by the first data record and the second data record.

Yet another embodiment of the invention is a computer system for supporting a clearinghouse for derivatives trades, which includes a web server that receives a request for a web page from a remote computer and provides a first graphical user interface to the remote computer in response to the request. The web server also receives, through the first graphical user interface, a selection of which fields a user at the remote computer would like to have on a derivatives trade entry screen, and a selection of one or more default values to be automatically entered on the derivatives trade entry screen. The web server provides a second graphical user interface remote computer, which includes the derivatives trade entry screen with the selected fields shown and the selected default values already entered into entry fields. The web server subsequently receives, through the second graphical user interface, an input of data representing a derivatives trade. The computer system in this embodiment further includes a database server that maintains a database of profiles for users of the computer system, including that of the user at the remote computer, and receives, from the first computer, the selection of default values and the selection of fields. The database server then updates the profile of the user in the database based on the received selection of default values and received selection of fields.

In still another embodiment of the invention the web server receives, from the remote computer, the identity of a plurality of subaccounts, an indication of how the derivatives trade is to be allocated among the plurality of subaccounts; and displays, on the graphical user interface, a list of the plurality of subaccounts and the allocation of the derivatives trade among the plurality of subaccounts.

In still another embodiment of the invention, the computer system includes a mainframe computer for receiving data regarding derivatives trades, a first application server for processing data regarding derivatives trades received by the mainframe computer, a second application server for processing data regarding derivatives trades received by the web server, and a router for routing network traffic between the mainframe and the first application server, and for routing network traffic between the web server and the second application server. The first and second application servers receiving input data from the web server, analyze the input data to determine what action to take regarding the data, and make calls to the database server to store the input data in the database. The computer system may also have a firewall that screens network traffic coming into the computer system through the internet, including network traffic from the remote computer, and an authentication server that verifies, in cooperation with the web server, the identity of a user at the remote computer in response to a login attempt by the user.

Yet another embodiment of the invention is a computer system for supporting a derivatives-trading exchange that has a first computer that maintains a database. The database has a first table having a row that defines a general category of operation that can be performed, and a second table having a row that defines a unit of work within the general category. The row of the first table has an entry that identifies the row of the second table. The database also has a third table having a row that defines a logical operation to be performed to carry out the unit of work. The row of the second table has an entry that identifies the row of the third table. The database also has a fourth table having a row having a reference to computer code for carrying out the logical operation. The row of the third table has an entry that identifies the row of the fourth table. The computer system also has a second computer communicatively linked to the first computer. The second computer receives data representing a derivatives trade, requests the first computer to traverse the respective rows of the respective first, second, third and fourth tables in order to find the computer code, and executes the computer code to process the data. When the second computer executes the computer code, it may identify an object oriented programming module and call methods that are specified by the module. Executing the computer code may entail identifying a Java Bean and calling Java methods that are specified by the Bean. The first, second and third tables may be related in such a way that they form a decision tree.

### BRIEF DESCRIPTION OF THE DRAWINGS

FIG. 1 illustrates an example of a computer system according to an embodiment of the invention;

FIG. 2 illustrates another example of a computer system according to an embodiment of the invention;

FIG. 3 illustrates an example of a home page according to an embodiment of the invention;

FIG. 4 illustrates a login dialog box according to an embodiment of the invention;

FIG. 5 illustrates an example of a setup interface according to an embodiment of the invention;

FIG. 6 illustrates an example of a trade summary interface according to an embodiment of the invention;

FIGS. 7a and 7b illustrate an example of a position transfer interface according to an embodiment of the invention;

FIG. 8 illustrates an example of a user interface that permits a user to request that one record of a trade be edited to match another record for the opposite side of the same trade; and

FIGS. 9 and 10 illustrate a logical decision tree according to an embodiment of the invention.

### DETAILED DESCRIPTION OF THE INVENTION

An example of a computer system configured according to an embodiment of the invention will now be described. Following the description of the computer system, functions that can be carried out in various embodiments of the invention will be described. These functions will be described in the context of the example computer system and, in some cases, be described as being carried out by specific components of the computer system. It should be understood, however, that the various embodiments of the invention are not tied to any specific piece of computer hardware or any particular architecture.

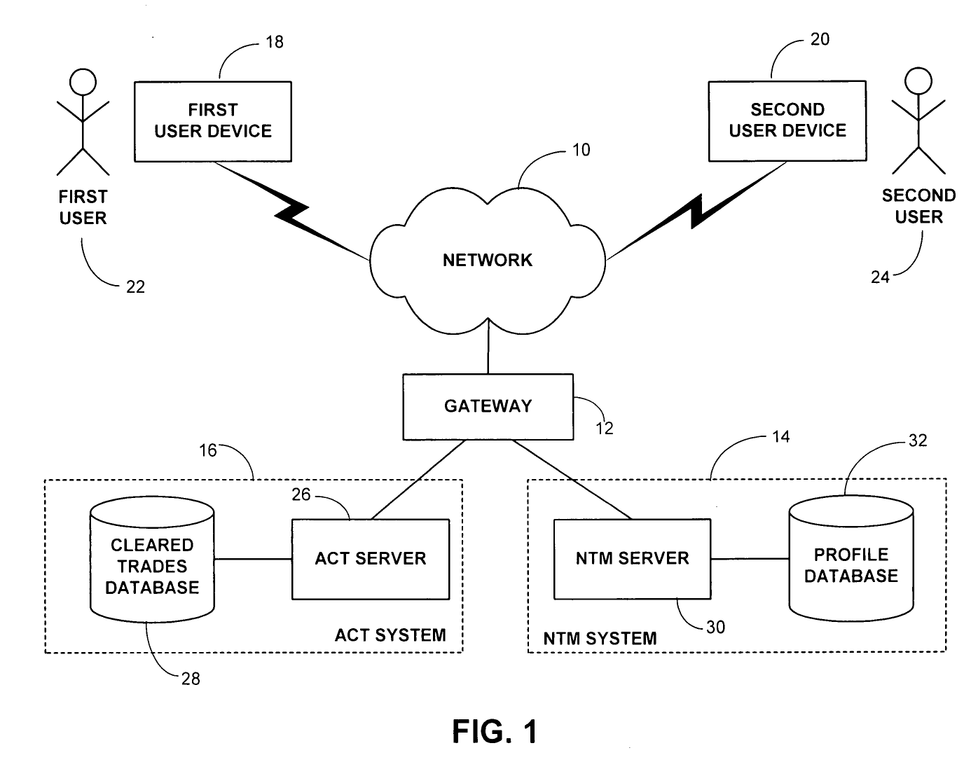

Referring to FIG. 1, the example computer system includes a network 10 , a gateway 12 , a New Trade Management (NTM™) system 14 , and an Allocation and Claim Transactions (ACT®) (hereinafter “ACT”) system 16 . The network 10 may be implemented in a variety of ways including, but not limited to, a local area network (LAN), a wide area network (WAN), an Extranet, an Intranet, or the Internet. According to one implementation, the network 10 is accessible through the World Wide Web or other public network, which provides a communication path between first and second user devices 18 and 20 and the gateway 12.

The computer system of FIG. 1 can accommodate any number of users. To aid in illustrating the invention, however, FIG. 1 includes two users—a first user 22, operating on the first user device 18, and a second user 24, operating on a second user device 20. Although the first and second users 22 and 24 are depicted as individual people, the term “user” as used herein may include a group of individual users, a trading firm or a financial institution. The first user device 18 and the second user device 20 may be implemented as any type of stationary or mobile computing device, including a personal computer (desktop or laptop), a personal digital assistant (PDA), or a cellular telephone. The gateway 12 communicates with the first and second user devices 18 and 20 via the network 10.

The ACT system 16 includes an ACT server 26 and a database 28 of cleared trades (the “cleared trades database”). The ACT server 26 is communicatively linked to the gateway 12. The NTM system 14 includes an NTM server 30 and a database 32 of user profiles (the “profile database”). The NTM server 30 is also communicatively linked to the gateway 12. The functions of the gateway 12 include providing a front-end interface to users wishing to use the computer system, authenticating those users and routing communication between the first or second user devices and the ACT or NTM systems. Thus, it will be assumed in the following paragraphs that when communication occurs between either the ACT or NTM systems and the first or second user devices, that such communication passes through the gateway 12. The ACT server 26 and the NTM server 30 each provide various services for users of the computer system. These services will be described below in greater detail. It should be understood, however, that the services provided by the ACT and NTM systems may all be performed by a single computer or a single group of computers. The division of these services between an “ACT system” and an “NTM system” as described herein is just one of many possible architectures.

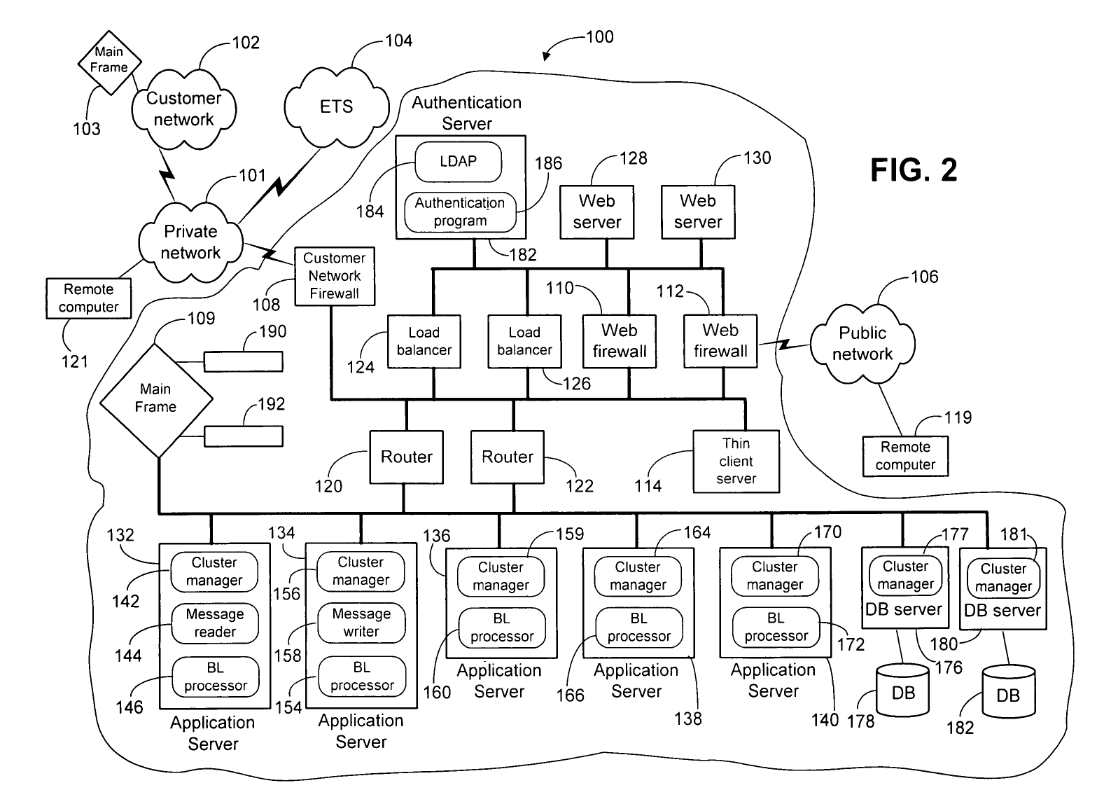

There are a variety of ways to implement the computer system of FIG. 1. One implementation is shown in FIG. 2, in which the ACT and NTM systems co-exist within the same network and same set of servers. The system, referred to herein as the data management system 100, is operated by a derivatives clearinghouse. The data management system 100 is communicatively linked with a private network 101. The private network 101 may be implemented in a variety of ways, including virtual private networking over the Internet or dedicated land lines. A customer network 102, and an electronic trading system (ETS) 104 are communicatively linked to the private network 101 and gain access to the data management system 100 via the private network 101. The data management system 100 is also communicatively linked to a public network 106. The customer network 102 represents the internal network of one of the participants of the clearinghouse, and includes a mainframe computer 103. It should be understood that there may be many customer networks communicating with the system 100, each with its own mainframe computer or computers. The ETS 104 represents the computer network of an electronic exchange. The public network 106 represents a publicly-accessible network such as the Internet, and includes a remote computer 119. Similarly, the private network 119 also includes a remote computer 121. In the examples discussed below, the remote computers 119 and 121 are assumed to be located at the place of business of one of the participants of the clearinghouse. Conceivably, some participants of the clearinghouse may access the data management system 100 via the private network 101, others may access the data management system 100 via the public network 106, while still others may use both the public and the private networks.

Communication between the data management system 100 and either the customer network 102 or the ETS 104 is generally carried out using some form of mainframe-to-mainframe protocol, such as MQ messaging. Communication between the data management system 100 and the remote computers 119 and 121 is generally carried out through a web-based interface using standard protocols such as TCP/IP and HTTP. When accessing the data management system 100, either through the public network 106 or through the private network 101, users generally use a personal computer executing a browser program. Remote computers 119 and 121 each represent such a personal computer (or functional equivalent thereof). Alternatively, users on the customer network 102 or the ETS 104 may communicate with the data management system 100 using mainframe messaging, in which they generally do not receive a graphical user interface (GUI) from the data management system 100.

The data management system 100 includes a customer network firewall 108 that regulates the ability of participant firms to access the data management system 100 from the customer network 102 and the ETS 104. The data management system 100 also includes a first web firewall 112 and a second web firewall 110 that regulate the ability of participant firms to access the data management system 100 from the public network 106. The first and second web firewalls 110 and 112 are each capable of load balancing, so that if one of them becomes much busier than the other, the busier web firewall can divert incoming web traffic to the other web firewall.

To assist users who may wish to have access through the public network 106, the data management system 100 has a thin client server 114. Users have the option to use the thin-client server 114 to compensate for having a low bandwidth connection over the public network 106. Users who require such access simply download thin-client software onto their workstation (e.g. the remote computer 119), and connect to the thin client server 114 over the public network 106. The data management system 100 treats the thin client server 114 as if it is part of the public network 106. Thus, data coming from the thin client server 114 is required to pass through one of the web firewalls 112 or 114.

The data management system 100 also includes a first web server 128 and a second web server 130. The web servers 128 and 130 store and manage web page content, and provide a GUI to users who access the data management system 100 through the public network 106 or the private network 101. Traffic to each of the web servers 128 and 130 is regulated by either a first load balancer 124 or a second load balancer 126. As the requests for web pages come in from the public network 106, the load balancers 124 and 126 allocate those requests to the first and second web servers 128 and 130 in a round-robin fashion so as to avoid overworking either web server. The second load balancer 126 acts as a back-up to the first load balancer 124, and can take over the first load balancer's job if the first load balancer 124 fails. There are a variety of possible implementations for the first and second load balancers 124 and 126. Examples include products by F5 Networks, Linux Virtual Server, and products by FalconStor Software®.

To authenticate users, the data management system 100 includes an authentication server 182. The authentication server 184 executes an authentication program 186, such as RSA ClearTrust®, SiteMinder® by Netegrity®, or IBM Tivoli Access Manageer. The authentication server 184 also executes a Lightweight Directory Access Protocol (LDAP) program 184. The authentication server 182 cooperates with the first and second web servers 128 and 130 to verify the identity and credentials of users accessing the data management system 100 via the public network 106.

The data management system 100 further includes a first router 120 and a second router 122. The first router 120 and the second router 122 direct network data traffic to various parts of the data management system 100 according to a set of rules relating to the IP addresses of the senders. Like the first and second web firewalls 112 and 114, the first and second routers 120 and 122 are capable of load balancing with one another, so that if one router becomes excessively busy, it can divert data traffic to the other router.

The data management system 100 also has a mainframe computer 109. The mainframe computer 109 is used by the data management system 100 to communicate with the customer network 102 and with the ETS 104 via the private network 101. The mainframe computer 109 has an incoming message queue 190 and an outgoing message queue 192. Messages received from the customer network 102 or the ETS 104 are stored in the incoming queue 190, while messages intended to be sent to the customer network 102 or the ETS 104 are stored in the outgoing queue 192. In one embodiment, the mainframe computer 109 executes an MQ messaging program, and communicates with the customer network 102 and the ETS 104 using MQ-formatted messages.

The data management system 100 further includes a first application server 132, a second application server 134, a third application server 136, a fourth application server 138 and a fifth application server 140. The programs executing on the first application server 132 include a cluster manager 142, a message reader 144, and a business logic processor 146. Similarly, the respective second, third, fourth and fifth application servers 143, 136, 138 and 140 have programs executing thereon. Table 1 below summarizes the programs executing on each of the application servers.

| | |
|---|---|
| Executing on | cluster manager 142 |
| the first | message reader 144 |
| applicaton | business logic (BL) processor 146 |
| server 132 | |
| Executing on | cluster manager 156 |
| the second | message writer 158 |
| application | business logic (BL) processor 154 |
| server 134 | |
| Executing on | cluster manager 159 |
| the third | business logic (BL) processor 160 |
| application | |
| server 136 | |
| Executing on | cluster manager 164 |
| the fourth | business logic (BL) processor 166 |
| application | |
| server 138 | |
| Executing on | cluster manager 170 |
| the fifth | business logic (BL) processor 172 |
| application | |
| server 140 | |

The first through fifth application servers operate in coordination with each other in a cluster. Each of the first through fifth application servers 132, 134, 136, 138 and 140 executes a cluster manager program 142, 156, 159, 164 and 170 respectively to facilitate this coordination. In general, the first and second application servers 132 and 134 process data received from the public network 106 (through a GUI on a browser), while the third, fourth and fifth application servers 136, 138 and 140 process data received from the customer network 102 and the ETS 104 (via MQ messages).

Each of the first through fifth application servers 132, 134, 136, 138 and 140 executes a respective business logic (BL) processor program 146, 154, 160, 166 and 172, which processes messages received from users of the data management system 100. It is these business logic processor programs that execute the computer code that underlies the ACT and NTM systems. The ACT and NTM code co-exists on each of the application servers.

When a message comes in from a user of the data management system 100, it is first screened by one of the firewalls, and is then routed by either the first or second router to one of the application servers. The application server that receives the message analyzes it according to the logic of a decision tree (described below in more detail). By traversing the decision tree, the application server can determine which pieces of computer code are to be invoked to perform operations on the data contained in the message. The decision tree itself is stored in the form of tables on a database server (which will also be described below in more detail), while the pieces of computer code are stored on the application server. In one embodiment, each of the application servers is a UNIX-based computer. The business logic processor program may be implemented in a variety of ways, including NET Server, by Microsoft®, IBM® WebSphere or JavaOne™ by Sun Microsystems™. The business logic that the business logic processor executes in this embodiment is implemented as a series of Java Beans that are associated with one another by the decision tree. By traversing the decision tree, the application server determines which Bean or Beans need to be invoked to process the message.

The data management system 100 also includes a first database server 176 and a second database server 180. The first database server 176 manages a database 178 that contains information regarding executed trades that have been accepted by the clearinghouse. The database 178 also contains tables that define the decision tree used by the application servers. The second database server 180 manages a database 182, which is a copy of the database 178 managed by the first database server 176. The first and second database servers 176 and 180 coordinate with one another as a cluster. To this end, the first database server 176 and the second database server 181 run cluster managers 177 and 181, respectively. The cluster managers 177 and 181 and the cluster manager programs on the application servers may be implemented in any of a number of ways, including IBM® eServer, Veritas™ cluster management software, or Beowolf by Aspen Systems. The database servers 176 and 180 also have a variety of possible database packages, including IBM® DB2, Oracle® Database 8i, or Microsoft® SQL Server software. The database systems may run on a variety of platforms, including UNIX, Windows, or Linux.

The first application server 132 and the second application server 134 also run programs for communicating with the mainframe computer 109. The first application server 132 executes a message reader 144 for reading messages from the incoming queue 190 of the mainframe computer 109, while the second application server 134 executes a message writer 158 for adding messages to the outgoing queue 192 of the mainframe computer 109. In an embodiment of the invention, the message reader 144 and the message writer 158 are each a client-side MQ messaging program. When a message comes in from the customer network 102 or the ETS 104, it is first screened by the customer network firewall. Then, either the first router 120 or the second router 122 routes it to the mainframe computer 109, which puts the message into the incoming message queue 190. The first application server 132 reads the message from the incoming message queue 190 and sends it to one or more of the third, fourth and fifth application servers 136, 138 and 140. The choice of which of these latter three application servers receives the message is made by the cluster manager 142 that executes on the first application server 132. The cluster manager 142 may determine that the most efficient way to process the message, for example, is to send it to the third, fourth and fifth application servers 136, 138 and 140 for parallel processing.

The first and second application servers 132 and 134 each interact with the first and second web servers 128 and 130 to provide dynamic content on the web pages that the first and second web servers 128 and 130 transmit to users who access the data management system 100 via the public network 106. For example, if a user on the public network 106 requests a web page that lists the most recently accepted executed trade for the user's trading firm (which is a participant of the clearinghouse), the first and second web servers 128 and 130 create the overall format of the web page, but the selection of which kind of trade data is to be displayed as well as the trade data itself is made by one or both of the first and second application servers 132 and 134.

The functionality that the data management system illustrated in FIGS. 1 and 2 provides to users, and the way in which that functionality is provided in an embodiment of the invention will now be described. As discussed previously, the execution of a trade occurs either in a trading pit, where the trade is conducted verbally, including the use of hand gestures, or through an electronic trading system. When a buyer and a seller commit to a price for which a future or option is to be bought/sold, and to any other required terms, the trade is said to have been “executed.” The buyer and the seller each enter data regarding the executed trade (or have this data entered for them) using some type of computer interface. Based on the entered data, two records for the executed are created: a record for the buyer and a record for the seller. These records are then sent to a clearinghouse to be matched (the open outcry method), or are first matched and then sent to the clearinghouse (the electronic trading method). An example of a scenario in which the records are sent unmatched to the clearinghouse is as follows. Referring to FIG. 2, a first broker offers to sell a certain quantity of corn futures on the floor of a derivatives exchange. A second broker on the derivatives exchange accepts the offer.

A clerk working for the first broker's firm enters the first broker's record of the trade (i.e. the seller's record) into a terminal connected to the mainframe 109 of the customer network 102. The mainframe 103 creates an MQ message representing the first broker's record and transmits the message through the private network 101 to the data management system 100. The message is screened by the customer network firewall 108, and permitted to pass to the first router 120. The first router 120 routes the message to the mainframe 109 of the data management system 100. The mainframe 103 puts the message into the incoming message queue 190. The message reader 144 of the first application server 132 subsequently reads the message from the incoming message queue 190. The first application server 132 then transmits the message to the third application server 136.

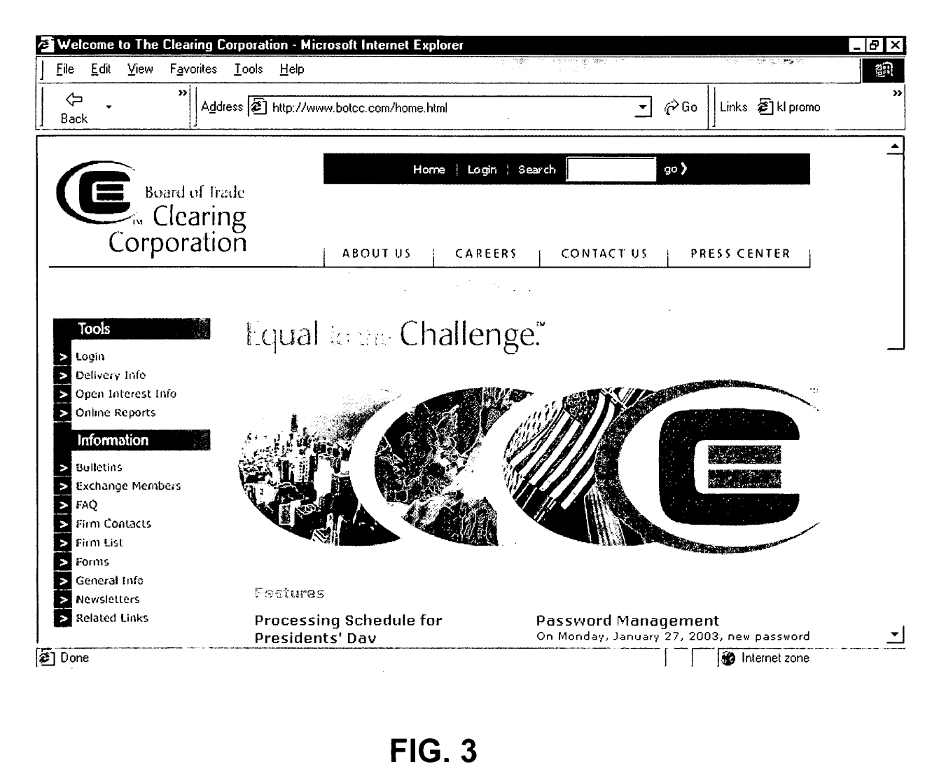

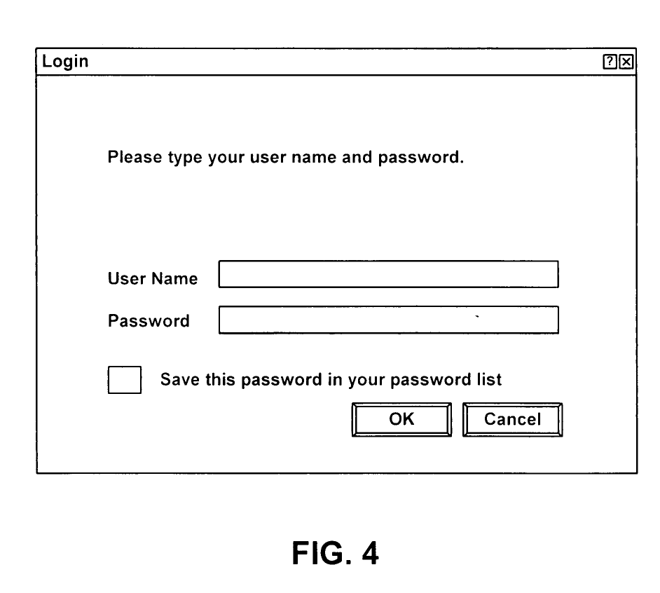

A clerk working for the second broker's firm logs on to the remote computer 119 and executes a web browser program. Through the web browser program, the clerk accesses the data management system 100 over the public network, and requests the home page of the data management system 100. After the request is screened by the first web firewall 112, it is permitted to pass to the first router 120. The first router 120 routes the request to the first web server 128. The first web server 128 transmits the homepage to the remote computer 119. FIG. 3 shows an example of such a home page. The clerk then selects “login.” In response, the first web server 128 transmits a login dialog box (FIG. 4). The clerk then logs in. The clerk enters a username and password, which is transmitted back to the first web server 128. The first web server 128 relays the username and password to the authentication server. The authentication program 186, in conjunction with the LDAP program 184, verifies the username and password, and indicates to the first web server 128 that it is OK to continue interacting with the remote computer 119. The first web server 128 then provides a web page to the remote computer 119 that allows the clerk to enter the second broker's record of the executed trade (i.e. the buyer's record) into the remote computer 119. The second broker's record is then transmitted to the first web server 128 using standard Internet protocols. The first web server 128 transmits this record to the third application server 136 (via the first router 120).

The third application server 136 works in cooperation with the first DB server 176 to store both the first broker's record of the executed trade and the second broker's record of the executed trade in the database 178 maintained by the first DB server 176. The data management system 100 will eventually attempt to match the first broker's record and the second broker's record with one another so that the clearinghouse can clear the executed trade.

If the trade between the first broker and the second broker took place on an electronic exchange in which the buyer's and seller's records of the executed trade were already matched by the time the data is received by the data management system 100, the process would occur as follows. The ETS. 104 creates an MQ message representing both the first and second broker's record of the trade (pre-matched) and transmits the message through the private network 101 to the data management system 100. The message is screened by the customer network firewall 108, and permitted to pass to the first router 120. The first router 120 routes the message to the mainframe 109 of the data management system 100. The mainframe 103 puts the message into the incoming message queue 190. The message reader 144 of the first application server 132 subsequently reads the message from the incoming message queue 190. The first application server 132 then transmits the message to the third application server 136. The third application server 136 works in cooperation with the first DB server 176 to insert the record of the executed trade in the database 178 maintained by the first DB server 176. If appropriate, the clearinghouse will subsequently accept the executed trade.

Periodically, the data management system 100 runs a “match cycle,” in which it attempts to match each buyer's trade record stored in the databases of the first and second DB servers 176 and 180 with a corresponding seller's record. At the end of each trading day, the data management system 100 tallies up the gains and losses for each of the participants of the clearinghouse, and calculates a final monetary value for each participant for that day. Each gain is treated as a positive number, while each loss is treated as a negative number. Whether or not a trade is a gain or loss for a buyer or seller requires a calculation of the difference between the closing price of the derivative that was traded and the price for which the derivative was bought or sold. In general, every trade results in either the buyer or seller having a “gain” and the opposing party having a “loss” with respect to that trade. It is also possible for both parties to come out “even.” The day-end monetary value for each participant is either a debit or a credit. If a participant ends the trading day with a net debit, then the clearinghouse deducts the amount of the debit from the participant's bank account. Likewise, if the participant ends the trading day with a net credit, then the clearinghouse adds the amount of the credit to the participant's account. This daily “marking-to-market” of trades that have been accepted by the clearinghouse is referred to as “settlement.”

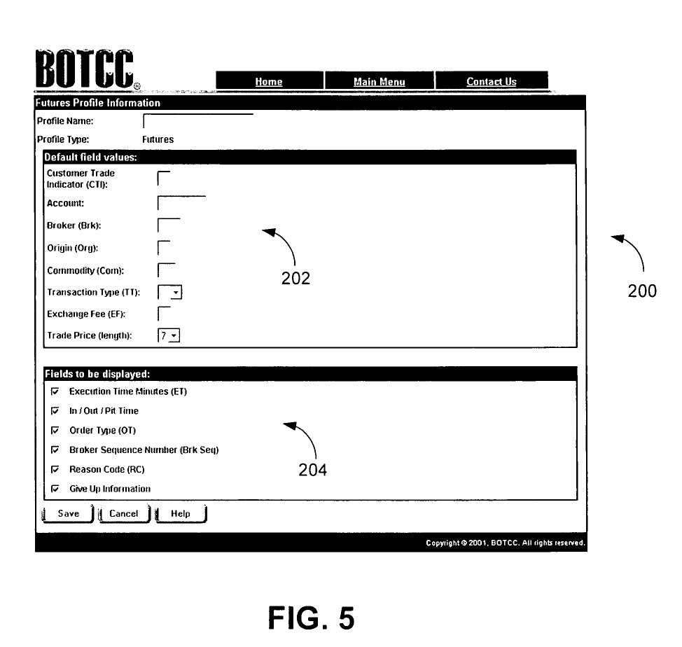

According to an embodiment of the invention, the data management system 100 of FIG. 1 allows a user to customize the appearance of a trade entry screen. The trade entry screen may be used on the floor of a derivative trading marketplace to enter data regarding one or more trades that have been previously executed in the derivative trading marketplace. A user may, for example, choose which data entry fields are to be displayed on the trade entry screen. Once the user determines which data entry fields are to be displayed on the trade entry screen, the user may choose which of those data entry fields, if any, are to receive default values and what those default values are. Collectively, the user's preferences regarding the appearance of his or her trade entry screen are referred to as the user's “profile.” A user may set up any number of profiles. For example, the user can set up a different profile for each commodity that the user trades. The user may set up a profile through a setup interface. An example of such a setup interface is shown in FIG. 5. The setup interface 200 has a list 202 of the available entry fields for which the user may specify default values, and a list 204 of information fields that the user may select to be displayed. Once the user enters the field values in the entry field list 202, and selects which information fields of the information field list 204 are to be displayed, the data management system 100 stores these preferences in a database. For the system depicted in FIG. 1, the database in which the profile is stored is the profile database. For the data management system 100 of FIG. 2, the user's profile is stored in the databases 178 and 182 maintained by the first and second database servers 176 and 180.

An example of how a user establishes a profile using the interface of FIG. 5 will now be described. In this example, it is assumed the user wishes to have the following default values for his or her trade entry screen.

| | Default | |
|---|---|---|
| Field Name | value | Meaning |
| Customer Trade Indicator (CTI) | 4 | Executed for the |
| | | benefit of some other |
| | | party |
| Account | (none) | No default value |
| Broker (Brk) | DBT | Trades executed by a |
| | | broker using this |
| | | acronym |
| Origin (Org) | 1 | The trade is for a |
| | | customer account |
| Commodity (Com) | C | The commodity on the |
| | | trade execution is corn |
| Transaction Type (TT) | 6 | It is a spread |
| | | transaction |
| Exchange Fee (EF) | (none) | No default value |
| Trade Price (length) | 6 | Six characters are |
| | | required to identify |
| | | the actual price. |

The user enters these values in the appropriate fields of the interface of FIG. 5. The user may modify one or more field values by going back to that specific field or the user may select the “cancel” button.

Referring again to FIG. 5, the user also has the option to select what information is to be displayed on the trade entry screen. For example, the user may select one or more of the following:

Execution Time in Minutes (ET)

In/Out/Pit Time

Order Type (OT)

Broker Sequence Number (Brk Seq)

Reason Code (RC)

Give Up Information

In FIG. 5, all of these types of information have been selected from the information field list, and, thus, all of these types of information will appear on the user's trade entry screen.

Once the user has configured the trade entry screen according to his or her preferences, the user can begin entering executed trades. The use of the trade entry screen to enter data regarding trades that have already been executed is illustrated as follows. A clerk of a participant firm of a derivatives clearinghouse receives written details regarding a trade previously executed between one of the firm's brokers and an opposing broker on the floor of a derivatives exchange. The clerk logs into the data management system 100 via the public network 100 and receives the trade entry screen from the first web server 128. The clerk then enters data regarding the executed trade. Such data includes the identity of the opposing broker's firm, the initials of the opposing broker, the commodity that underlies the derivative and the selling price. A second clerk, working for the opposing broker's firm, also receives written details regarding the trade, and does the same thing. The data management system 100 creates two records for the trade and stores those two records in the databases of the first and second database servers 176 and 180.

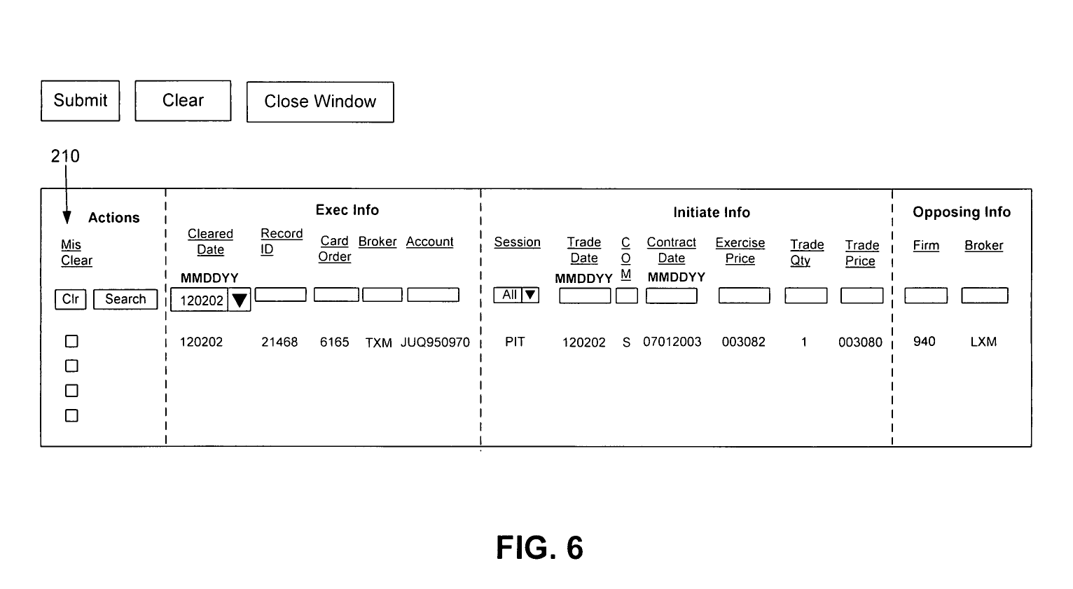

In various embodiments of the invention, the data management system of FIG. 2 maintains a database of cleared trades and, upon the request of users, displays the summary of the cleared trades. In one embodiment, data regarding the trades are maintained for four or five days after they are cleared. An example of a user interface for displaying the summary of cleared trades to a user is shown in FIG. 6. If a user determines that a cleared trade listed in the summary is incorrect in some way (as a result, for example, of an internal reconciliation procedure conducted by the user's trading firm), the user may designate the cleared trade as a “misclear” by checking a box in the first column 210. The data management system 100 responds by automatically generating a new transaction that offsets the miscleared trade. The data management system 100 then transmits a message to the opposite party involved in the original miscleared trade. The message gives the opposite party the option to “claim” (accept) the new transaction. If the other party claims the new transaction, then, in effect, a new, offsetting transaction is created. The clearinghouse then clears the new transaction and generates a new record in the database corresponding to the new transaction. Thus, the originally miscleared trade gets nullified.

A more detailed example of how the misclear feature of the data management system 100 operates according to an embodiment of the invention will now be described. In this example, it is assumed that a trade occurs between two pit traders in a commodity exchange—the first trader being the buyer and the second trader being the seller. Through a series of very quick hand signals, the first trader agrees to buy March corn at $5.10 from the second trader. The first trader's clerk and the second trader's clerk both erroneously enter the price of the transaction as $5.11. Furthermore, the first and second traders' firms do not catch the mistake, and allow the trade to be matched. The clearinghouse therefore accepts the trade and the data management system 100 creates a record for the trade in the databases of the first and second database servers 176 and 180. The record is classified under the category of “cleared trades.”

Upon later review, the second trader realizes the mistake. Using the remote computer 119, the second trader requests a summary of cleared trades from the data management system 100. In response, the data management system 100 retrieves, from the either of databases 178 and 182, records for those tradess in which the second user was a party. The ACT server then transmits a summary of cleared trades to the second user device, which displays the summary in the form of an interface like the one shown in FIG. 6. The second user locates the entry for the erroneously recorded trade in the summary, checks the “misclear” box to the left of the entry, and activates the “submit” button. The data management system 100 responds by electronically generating a new, offsetting transaction. The offsetting transaction reflects a purchase, by the second trader (who was the seller), of March corn at $5.11 from the first user (who was the buyer). The data management system 100 then notifies the first trader that the second trader wishes to negate the clearinghouse's acceptance of the trade. This notification may take the form of an electronic message that gets put onto the second trader's user interface. The electronic message asks the first trader whether the first trader wishes to claim or reject the transaction. In response, the first trader accepts the transaction. In other words, the first trader agrees that the original trade had been improperly accepted. In response, the data management system 100 creates a record for a new transaction (the purchase of March corn by the second trader from the first trader at $5.11). The new transactino is then designated as “accepted” in the databases of the first and second database servers 176 and 180. The record for the new transaction is then entered into the cleared trades database. Note that this new transaction is not based on a new trade, in the sense that the second trader did not actually purchase March corn at $5.11 from the first trader. The new transaction is simply a database record that is created for the purpose of having an audit trail and to enable the erroneously cleared trade to be backed out. This new record offsets the record of the original trade.

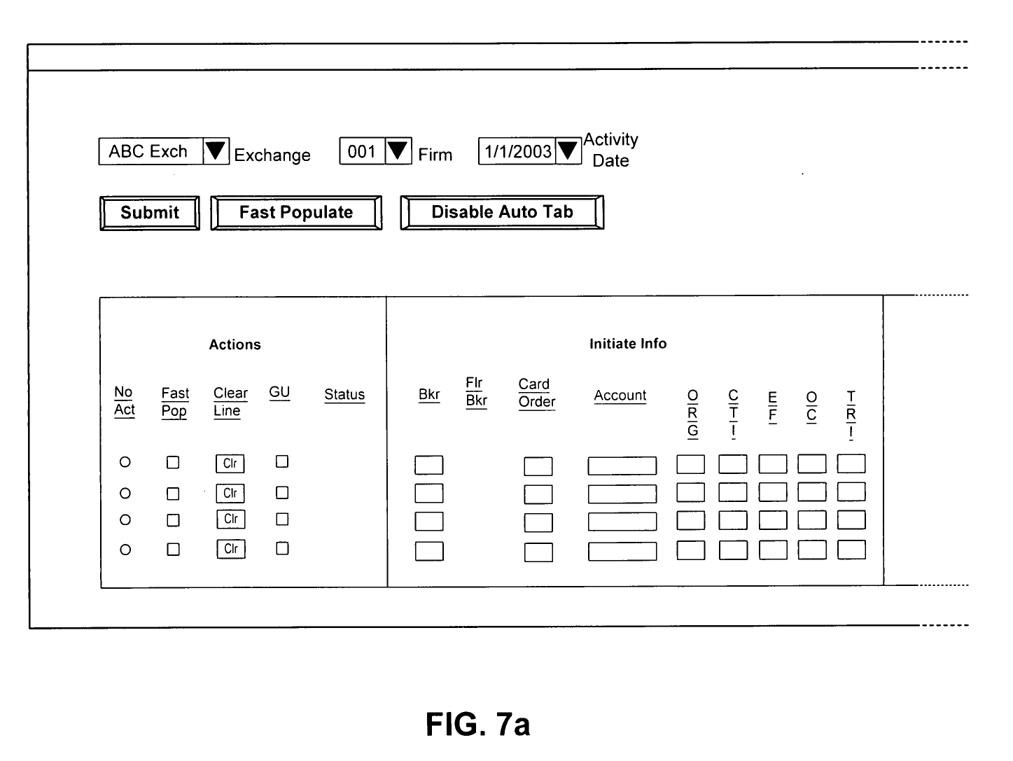

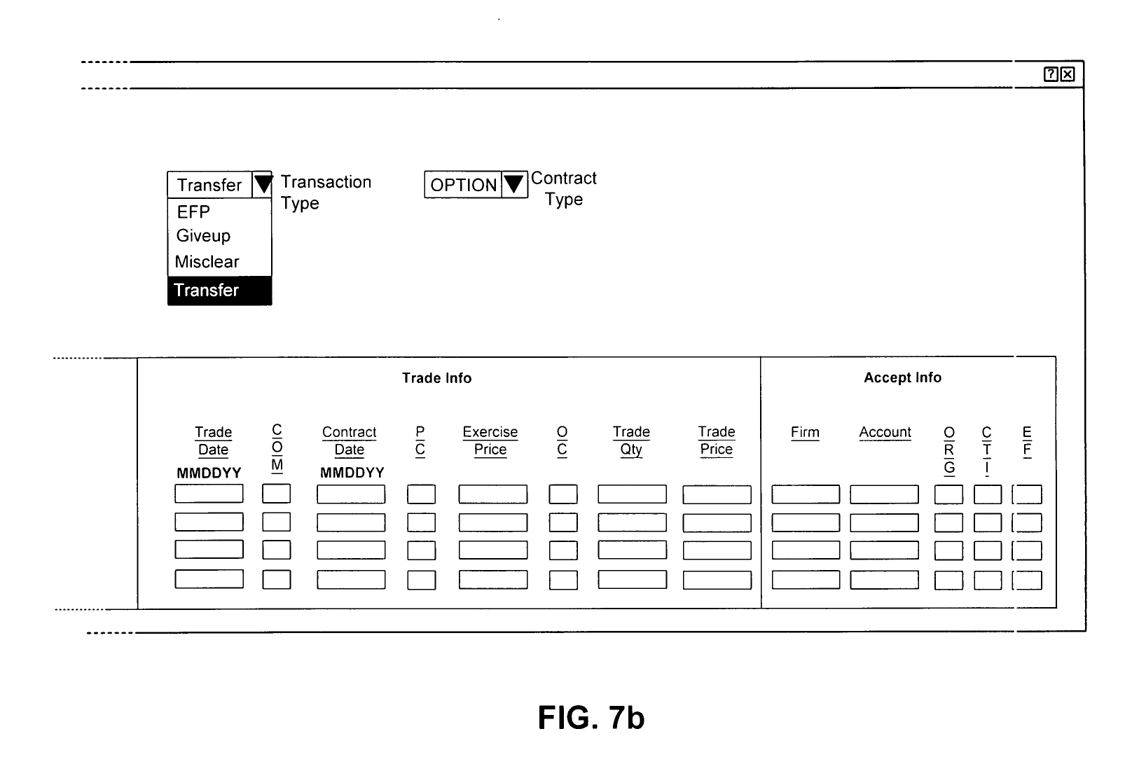

According to an embodiment of the invention, the data management system 100 (FIG. 2) allows a participant of a clearinghouse to initiate a one-sided transfer of a position to another participant. A “position” is a term used to describe the obligation of a buyer or seller with respect to a particular future or option contract. For example, assume that the first participant is the ABC Trading Firm, whose client is Acme Investment Corp. Acme Investment Corp. wishes to move its positions from the ABC Trading Firm to the second participant, the XYZ Trading Firm. To effect the move, a clerk at the ABC Trading Firm interacts with the data management system 100 via the remote computer 119 to obtain a position-transfer interface from the first web server 128. An example of a position transfer interface is shown in FIGS. 7a and 7b, with FIG. 7a showing the left portion and FIG. 7b showing the right portion. The position transfer interface includes fields for identifying the positions to be transferred. The clerk at the ABC Trading firm then fills a field for each of the positions belonging to the Acme Investment Corp. For example, if the Acme Investment Corp. has forty positions, including a mix of long and short positions on various commodities, the clerk enters the transaction identifier for each of the forty transactions. The clerk then enters the ID number of the second user (the XYZ Trading Firm) and activates a “submit” button. The data management system 100 sends one or more messages to the ABC Trading Firm, asking whether or not the ABC Trading Firm accepts the positions that the XYZ Trading Firm is attempting to transfer. If the XYZ Trading Firm accepts the positions, the data management system 100 automatically reflects the transfer in the databases of the first and second database servers 176 and 180. In addition to transferring positions, a variation of the above-described interface can also be used to transfer money from one firm to another. Instead of identifying positions, the ABC Trading Firm just enters a monetary amount and, optionally, comments explaining why the transfer is occurring. The XYZ Trading firm gets a notification and either accepts or declines the money transfer.

According to yet another embodiment of the invention, the data management system 100 allows a user to verify the validity of the customer's positions being transferred. The process carried out to accomplish this verification is referred to as an “equity run.” During an equity run, the data management system 100 calculates open trade equity values based on the settlement prices of the previous day's cleared trades.

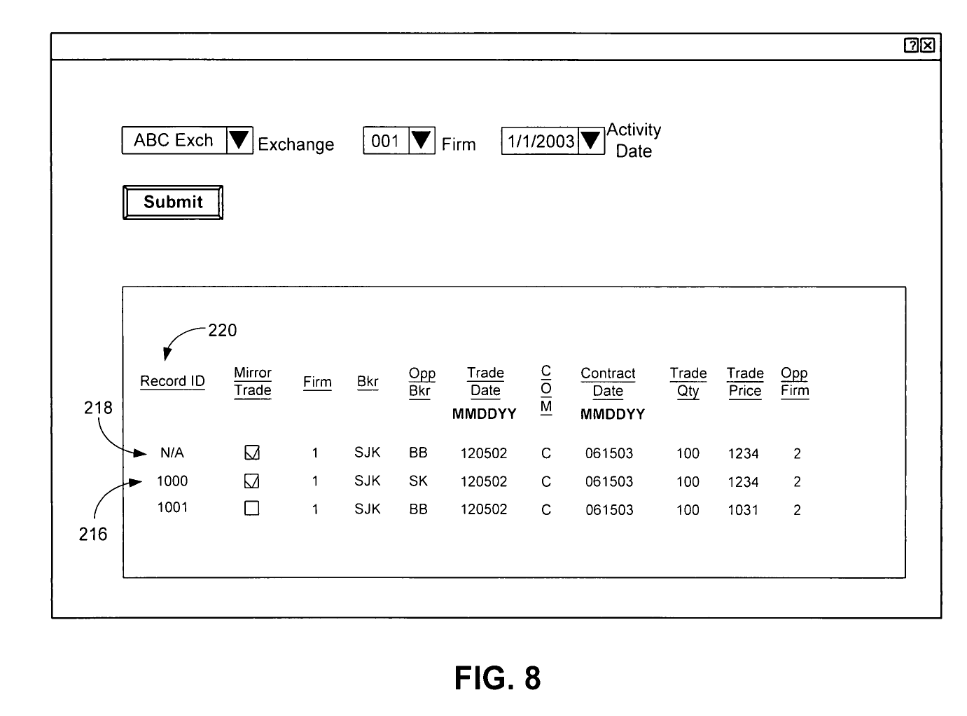

As has been previously discussed, when a trade occurs on a derivatives exchange, the buyer and seller will each enter data regarding the trade, thereby creating two separate records of the trade. To clear the trade, the clearinghouse will then have to match the two records to insure that certain critical data in the two records matches. An example of such critical data is the buy or sell price. Thus, the buyer's record and the seller's record should both show the same price. However, due to human error, either the buyer or seller may have made a mistake in entering the data. In an embodiment of the invention, the data management system 100 permits a user, who works for either the buyer or seller, to pull up the unmatched trades and determine whether the mistake was made on the part of the user's firm. If so, and if the party on the opposite side of the trade has the correct data in its record, the user can request that the data management system 100 simply edit the record of the user's firm so that it becomes identical to the opposing party's record. FIG. 8, shows a user interface in which this is done. In the example of FIG. 8, the unmatched trade records are sorted on the screen so as to increase the likelihood that records involving opposite sides of the same underlying trade are listed closely together. In FIG. 8, the first two entries in the list of unmatched trade records have identical substantive information, that the second entry has the opposing broker as “SK.” Note that the record ID of the first entry in the list contains the value “N/A.” This simply means that the record is one that the user's firm did not enter into the system, but rather represents data entered by a firm other than the user's firm. The data in the first entry does, however, correspond to a trade to which the user's firm was a party. The user will analyze this list and determine that the second entry is erroneous, because the opposing broker should have been “BB.” The user thus selects the second entry, since it is the one that was erroneous, and the first entry, which the user has determined represents the same trade as the second entry and which, in the determination of the user, contains the correct data (i.e. has the opposing broker listed as BB). Once the user clicks on the “submit” button, the database entry in the database 178 that corresponds to the second trade on the list is changed so that the information now matches that of the opposing party's (e.g. the opposing broker field now has “BB” instead of SK). In other words, the data management system 100 alters the second entry—the one with data entered by the user's firm—so that it now “mirrors” the data in the first entry—which was entered the opposing broker's firm.

Periodically, the data management system 100 searches through the database 178 of the first database server 176 (and its twin, the database 182 of the second database server 180) and attempts to match pairs of records, so that for each record entered by a buyer, there is a matching record entered by a seller. Once the records have been matched, the derivatives trade that those matched records represent can be accepted by the clearinghouse, and eventually designated as being cleared in the databases of the first and second database servers 176 and 180. Referring again to FIG. 8, once the user selects the first and second entries to be mirrored, and the data of the second entry is updated in the database, the data management system 100 will, during the next matching cycle, match the two records corresponding to the first and second entries. The trade that underlies those two matched records will then be cleared by the clearinghouse.

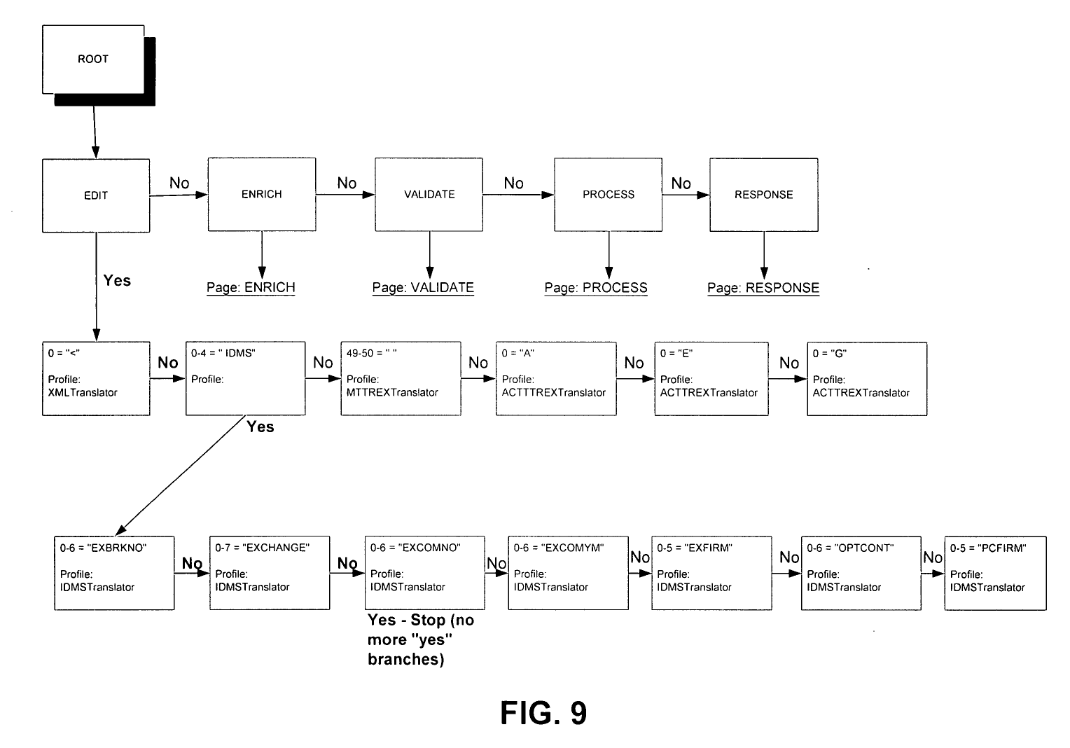

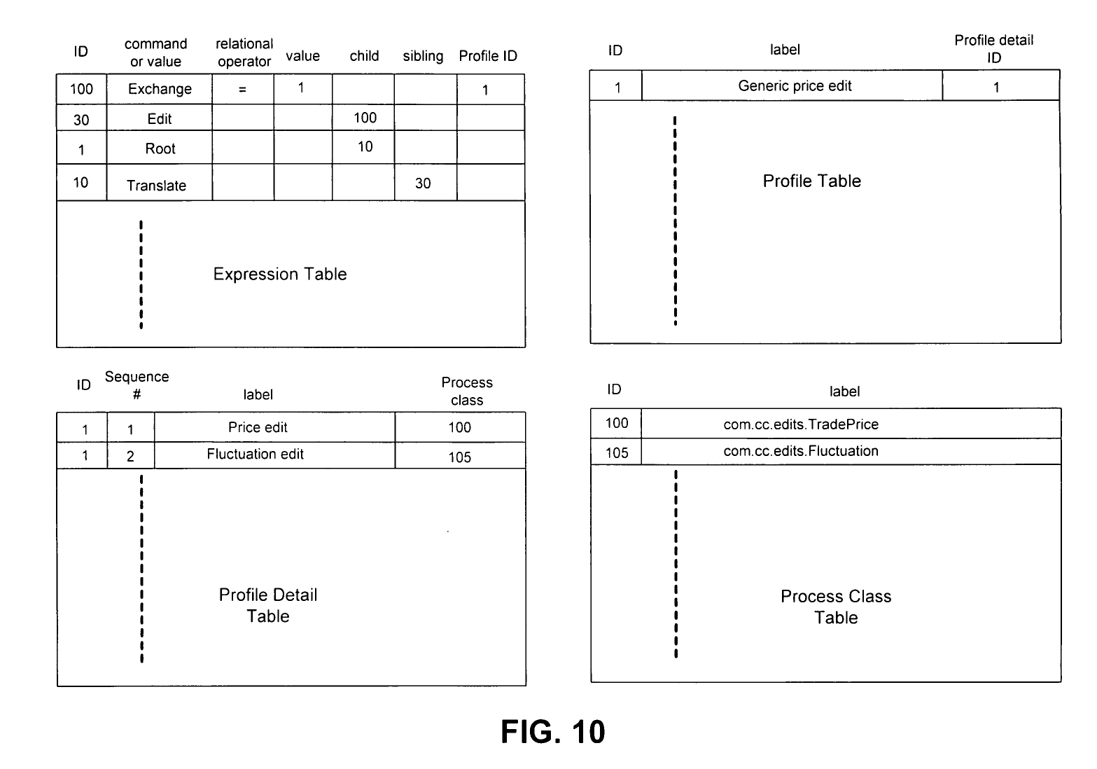

As discussed above, each of the application servers 132, 134,136, 138 and 140 of the data management system 100 (FIG. 2) executes business logic to process incoming data from the public network 106 or the private network 101. In one embodiment, the business logic is executed on the Websphere platform, in which a logical decision tree is traversed to determine which Java Bean or Beans need to be invoked to process the incoming data. An example of such a tree is shown in FIG. 8. An example of how this occurs will now be described with reference to FIG. 2, with reference to FIG. 9, and with reference to FIG. 10, which shows a set of tables that are stored in the database 178 of the first database server 176. Assume that the ETS 104 (FIG. 2) transmits a message through the private network 101. The customer network firewall 108 permits the message to pass through the system 100 and to the clearing house's mainframe computer 109, where it is placed into the incoming message queue. The message reader program 144 of application server A retrieves the message, and passes the message to the third application server 136. The third application server 136 then analyzes the message according to a decision tree stored in the database 178 of the first database server 176. The third application server 178 determines that the message needs to be edited into a standard format that the data management system 100 can use. This translation is represented by the “edit” branch of FIG. 9. The third application server 136 passes a command data structure containing the command “edit” along with a set of parameters back to the root of the decision tree.

Referring now to FIG. 10, in which the decision tree is shown broken down into its constituent tables, the process of walking through the EDIT branch of the tree of FIG. 9 will now be described. Starting at the Expression Table (FIG. 10), the row having an ID of 1 represents the root of the tree. Analyzing that row, the third application server 136 determines that, since there is no expression in that row, and that the child of the row has an ID of 10, it needs to jump to the row with the ID of 10 (Row #10). The third application server 136 then compares the command “edit” with the command listed in that row, which is “translate.” Since “edit” is not the same as “translate,” the third application server 136 determines whether Row #10 has any siblings. The third application server 136 determines that there is a sibling, which is Row #30, and jumps to the sibling. At the sibling (Row #30), the third application server 136 finds that the command listed in that row is “edit.” Since “edit” now evaluates as “true,” the third application server 136 jumps to the child of Row #30, which is Row #100. Row #100 indicates that if the Exchange ID=1, then profile 1 is to be used. In this example, the Exchange ID does equal 1, so the third application server 136 goes to the Profile Table and obtains the data in Row #1 of that table. Row #1 of the profile table corresponds to the profile Generic Price Edit. Furthermore, profile detail ID is 1, which indicates to the third application server 136 that it should go to the Profile Detail Table and start obtaining details having an ID of 1. In the Profile Detail Table, there are two profile details (rows) having an ID of 1. The first in sequence is “price edit.” It corresponds to process class #100. The third application server 136 refers to the process class table and finds the identifier for class #100, which is “com.cc.edits.TradePrice.” The third application server 136 then creates an instance of the class com.cc.edits.TradePrice, which is implemented in this embodiment as a Java Bean. The Bean contains the code required to perform the function “price edit.” Once that code has been executed, the third application server 136 goes to the next detail in the Profile Detail Table for profile 1.

The next detail in the sequence is “fluctuation edit,” is associated with class #105. The application server C refers to the row of the Process Class Table having an ID of 105. As shown in FIG. 10, that row indicates that the identifier for class #105 is “com.cc.edits.Fluctuation.” The third application server 136 then creates an instance of the class com.cc.edits.Fluctuation, which is implemented in this embodiment as a Java Bean. The Bean contains the code required to perform the function “fluctuation.” Once that code has been executed, the third application server 136 returns to the root of the decision tree and either performs functions according to another branch of the decision tree or waits for the next message to be passed to it.

It can thus be seen that a new and useful method for managing data regarding derivatives trades has been described. While preferred embodiments of this invention are described herein, including the best mode known to the inventors for carrying out the invention, it should be understood that the illustrated embodiments are examples only, and should not be taken as limiting the scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A computer system for supporting a derivatives clearinghouse, the clearinghouse having a plurality of participants, including a first participant and a second participant, the computer system comprising:
a web server that performs steps comprising:
receiving a request for a web page from a remote computer;
providing a graphical user interface to the remote computer in response to the request;
receiving, through the graphical user interface, a request for a list of previously accepted derivatives trades in which the first participant or a customer of the first participant was a party;
providing the list to the remote computer via the graphical user interface, wherein the list includes a previously executed trade that was carried out by the first and second participants or their respective customers and was accepted by the clearinghouse;
receiving, from the remote computer, an input indicating that the previously executed trade was improperly accepted; and
a database server communicatively linked with the web server, wherein the database server performs steps comprising:
maintaining a database of derivative trades that have been accepted by the clearinghouse;
retrieving, from the database, data representing the list of accepted trades for which the first participant is responsible;
providing the data to the web server for use in creating the list; and
creating an entry in the database that represents an offsetting transaction that has the effect of negating the acceptance of the previously executed trade.

2. The system of claim 1,
wherein the remote computer is a first remote computer, and the graphical user interface is a first graphical user interface,
wherein the web server performs further steps comprising:
presenting a second graphical user interface to a second remote computer; and
querying the second participant, via the second graphical user interface, regarding whether the clearinghouse's acceptance of the previously executed trade should be negated;
wherein the database server performs the creating step only if the second participant indicates that the clearinghouse's acceptance of the previously executed trade should be negated.

3. The system of claim 1, wherein the database server performs further steps comprising:
receiving a structured query language search command; and
searching the database in accordance with the structured query language search command,
wherein the retrieving step is performed as result of the searching step.

4. The system of claim 1,
wherein the web server receives user-entered data regarding the previously executed trade;
wherein the user-entered data is incorrect;
wherein, subsequent to web server receiving the user-entered data, the clearinghouse accepts the previously executed trade;
wherein the clearinghouse stores data concerning the previously execute trade in the database; and
wherein the data includes an indication that the previously executed trade has been accepted by the clearinghouse.

5. The system of claim 1, wherein the web server receives user-entered data regarding the previously executed trade, wherein the user-entered data is incorrect, and wherein
the clearinghouse performs steps comprising:
accepting the previously executed trade subsequent to web server receiving the user-entered data;
storing the user-entered data in the database;
indicating in the database that the previously executed trade has been accepted;
the web server performing further steps comprising:
presenting a graphical user interface to a remote computer of the second participant; and
querying the second participant, via the graphical user interface, regarding whether the acceptance of the previously executed trade between the first and second participants should be negated;
the database server performing further steps comprising:
receiving a structured query language search command; and
searching the database in accordance with the structured query language search command,
wherein the database server performs the step of retrieving data associated with the previously executed trade as result of the searching step, and
wherein the database server performs the creating step only if the second participant indicates that the acceptance of the trade should be negated.

6. The method of claim 1, wherein the web server displays, via the graphical user interface, an alert message relating to post-trading activity.

7. The method of claim 1, wherein the web server displays, via the graphical user interface, an alert message indicating that all post-trading activity needs to stop.

8. A computer system for managing data regarding a plurality of derivatives trades, wherein a derivative trade of the plurality was carried out between a first party and a second party, the computer system comprising:
a first server communicatively linked to a first remote computer and a second remote computer, wherein the first server performs steps comprising:
receiving a first data record from the first remote computer, the first data record reflecting data recorded by the first party regarding the derivatives trade;
receiving a second data record from the second remote computer, the second data record reflecting data recorded by the second party regarding the derivatives trade;
a second server that maintains a database, wherein the second server performs steps comprising:
storing the first and second data records in a database;
categorizing the first and second data records as unmatched;
in response to a query, retrieving, from the database, a plurality of unmatched data records in which the underlying trades involved the first party, including the first and second data records;
providing the plurality of unmatched data records, including the first and second data records, to the first server;
wherein the first server performs further steps comprising:
receiving the plurality of unmatched trade records, including the first and second data records, from the second server;
in response to a query from the first party, listing the contents of the plurality of unmatched trade records on a user interface;
displaying the user interface the first party on a display of a computer;
receiving an input from the first party via the computer on which the user interface is displayed, wherein the input indicates that the first data record and the second data record should match;
wherein the second server performs further steps comprising:
in response to the input received by the first server from the first party, editing the first data record so that it matches the second data record.

9. The computer system of claim 8, wherein the first server is a web server.

10. The computer system of claim 8, wherein the second server is a database server.

11. The computer system of claim 8, wherein the first and second remote computers communicate with the first server via the internet.

12. The computer system of claim 8, wherein the second server performs further steps comprising:
for those records categorized as unmatched, periodically attempting to match the records into pairs, such that each pair comprises a buyer's record of a particular derivatives trade and a seller's record of the opposing side of the trade; and
subsequent to the editing step, successfully matching the first data record and the second data record during one of the periodic attempts.

13. The computer system of claim 12, wherein, after the second server performs the matching step, the clearinghouse accepts the trade represented by the first data record and the second data record.

14. A computer system for supporting a derivatives clearinghouse having a plurality of participants, the computer system comprising:
a web server that performs steps comprising:
receiving a request for a web page from a remote computer;
providing a first graphical user interface to the remote computer in response to the request;
receiving, through the first graphical user interface, a selection of which fields a user at the remote computer would like to have on a derivatives trade entry screen;
receiving, through the first graphical user interface, a selection of one or more default values to be automatically entered on the derivatives trade entry screen;
providing a second graphical user interface to the remote computer, the second graphical user interface including the derivatives trade entry screen with the selected fields shown and the selected default values already entered into entry fields and;
receiving, through the second graphical user interface, an input of data representing a derivatives trade; and
a database server that performs steps comprising:
maintaining a database of profiles for users of the computer system, including that of the user at the remote computer;
receiving, from the first computer, the selection of default values and the selection of fields; and
updating the profile of the user in the database based on the received selection of default values and received selection of fields.

15. The computer system of claim 14, wherein the web server performs further steps comprising:
receiving, from the remote computer, the identity of a plurality of subaccounts;
receiving, from the remote computer, an indication of how the derivatives trade is to be allocated among the plurality of subaccounts; and
displaying, on the graphical user interface, a list of the plurality of subaccounts and the allocation of the derivatives trade among the plurality of subaccounts.

16. The computer system of claim 14, further comprising:
a mainframe computer for receiving data regarding derivatives trades;
a first application server for processing data regarding derivatives trades received by the mainframe computer;
a second application server for processing data regarding derivatives trades received by the web server; and
a router for routing network traffic between the mainframe computer and the first application server, and for routing network traffic between the web server and the second application server.

17. The computer system of claim 14, further comprising:
an application server that performs steps comprising:
receiving the input data from the web server;
analyzing the input data to determine what action to take regarding the data; and
making calls to the database server to store the input data in the database.

18. The computer system of claim 14, further comprising:
an application server that performs steps comprising:
receiving the input data from the web server;
analyzing the input data to determine what action to take regarding the data; and
making calls to the database server to store the input data in the database;
a firewall that performs steps comprising:
screening network traffic coming into the computer system through the internet, including network traffic from the remote computer.

19. The computer system of claim 14, further comprising:
an application server that performs steps comprising:
receiving the input data from the web server;
analyzing the input data to determine what action to take regarding the data; and
making calls to the database server to store the input data in the database;
a firewall that performs steps comprising:
screening network traffic coming into the computer system through the internet, including network traffic from the remote computer;
an authentication server that performs steps comprising:
in cooperation with the web server, verifying the identity of a user at the remote computer in response to a login attempt by the user.

20. A computer system for supporting a derivatives clearinghouse, the computer system comprising:
a first computer that maintains a database, the database comprising:
a first table having a row that defines a general category of operation that can be performed;
a second table having a row that defines a unit of work within the general category, wherein the row of the first table has an entry that identifies the row of the second table;
a third table having a row that defines a logical operation to be performed to carry out the unit of work, wherein the row of the second table has an entry that identifies the row of the third table;
a fourth table having a row having a reference to computer code for carrying out the logical operation, wherein the row of the third table has an entry that identifies the row of the fourth table;
a second computer communicatively linked to the first computer, wherein the second computer performs steps comprising:
receiving data representing a derivatives trades that has been previously carried out in a derivatives exchange or in an over the counter marketplace;
requesting the first computer to traverse the respective rows of the respective first, second, third and fourth tables in order to find the computer code; and
executing the computer code to process the data.

21. The system of claim 20,
wherein the step of executing the computer code comprises identifying an object oriented programming module and calling methods that are specified by the module.

22. The system of claim 20,
wherein the step of executing the computer code comprises identifying a Java Bean and calling Java methods that are specified by the Bean.

23. The system of claim 20, wherein the first, second and third tables are related in such a way that they form a decision tree.
